(19) United States
(12) Patent Application Publication
(10) Pub. No.: US 2006/0180153 A1
(43) Pub. Date: Aug. 17, 2006

(54) Assembly for mounting a device to a mask

(76) Inventors: Bernie Schaub, University Heights, OH (US); Dan Zimet, S. Euclid, OH (US); Mike Krnc, Medina, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/044,129

(22) Filed: Jan. 27, 2005

(51) Int. Cl. A62B 18/08

(52) U.S. Cl. 128/206.16

(57) ABSTRACT

An adapter assembly for attaching a device, such as a communication device, to a portion of a mask, such as a filter port. The assembly includes an adapter ring that attaches to the mask to effect a seal of the filter port. A mounting assembly attaches to the device and is releasably engageable with the adapter ring to support the device on the mask for rotation relative to the mask without breaking the seal of the filter port. Preferably the adapter ring attaches to the mask with a threaded connection, and the device rotates on the adapter ring with less force in a loosening direction of the threaded connection.

### TECHNICAL FIELD

The present invention relates to a mask and a way of supporting a device on the mask. In particular, the present invention relates to an adapter assembly for mounting a communication device on a filter port of a mask.

### BACKGROUND OF THE INVENTION

A known mask for protection from toxins and noxious fumes has two filter ports, located on opposite sides of the mask. A filter in the form of a canister can be screwed onto either filter port, allowing the user of the mask to breathe filtered air. The other filter port, the one that is not being used, is sealed with a seal ring that is screwed onto the port.

It is known to place a voice emitter in this other port, to allow a person wearing the mask to project sound while wearing the mask. The voice emitter is held in the filter port, effecting a seal, by a seal ring. In the past, some users have attempted to mount a microphone and/or boom speaker on the filter port, over the voice emitter. This has been problematic, however, because the device that is attached is held on with a screw threaded connection, replacing the seal ring, and if this device comes loose by rotating, the seal at the filter port is lost.

### SUMMARY OF THE INVENTION

The present invention relates to an adapter assembly for attaching a device, such as a communication device, to a portion of a mask, such as a filter port of a mask. The assembly includes an adapter ring that attaches to the mask to effect a seal of the filter port. A mounting assembly attaches to the device and is releasably engageable with the adapter ring to support the device on the mask for rotation relative to the mask without breaking the seal of the filter port. Preferably the adapter ring attaches to the mask with a threaded connection, and the device rotates on the adapter ring with less force in a loosening direction of the threaded connection.

### BRIEF DESCRIPTION OF THE DRAWINGS

Further features and advantages of the present invention will become apparent to those of ordinary skill in the art to which the invention pertains from a reading of the following description together with the accompanying drawings, in which:

FIG. 1 is a schematic illustration of a mask and an adapter assembly that is a first embodiment of the invention, supporting a communication device on the mask;

FIG. 2 is a sectional view of a portion of the mask including a filter port and showing a voice emitter sealed in the filter port by a seal ring;

FIG. 3 is an exploded sectional view showing the adapter assembly of FIG. 1 in position adjacent the filter port;

FIG. 4 is an exploded perspective view of the adapter assembly and the voice emitter;

FIG. 5 is a schematic radial sectional view showing the parts of the adapter assembly in one position of rotation;

FIG. 6 is a schematic sectional view taken at a right angle to FIG. 5 and showing the parts of the adapter assembly in the one position of rotation;

FIG. 7 is a sectional view similar to FIG. 5 showing the parts of the adapter assembly in another one position of rotation;

FIG. 8 is a sectional view similar to FIG. 6 and taken at a right angle to FIG. 7 and showing the parts of the adapter assembly in the other position of rotation;

FIG. 9 is an enlarged schematic view of one notch that forms part of the adapter assembly;

FIG. 10 is an exploded perspective view showing the adapter assembly on a communication device shown in phantom; and

FIG. 11 is a view similar to FIG. 9 of one notch that forms part of an adapter assembly in accordance with a second embodiment of the invention.

### DETAILED DESCRIPTION

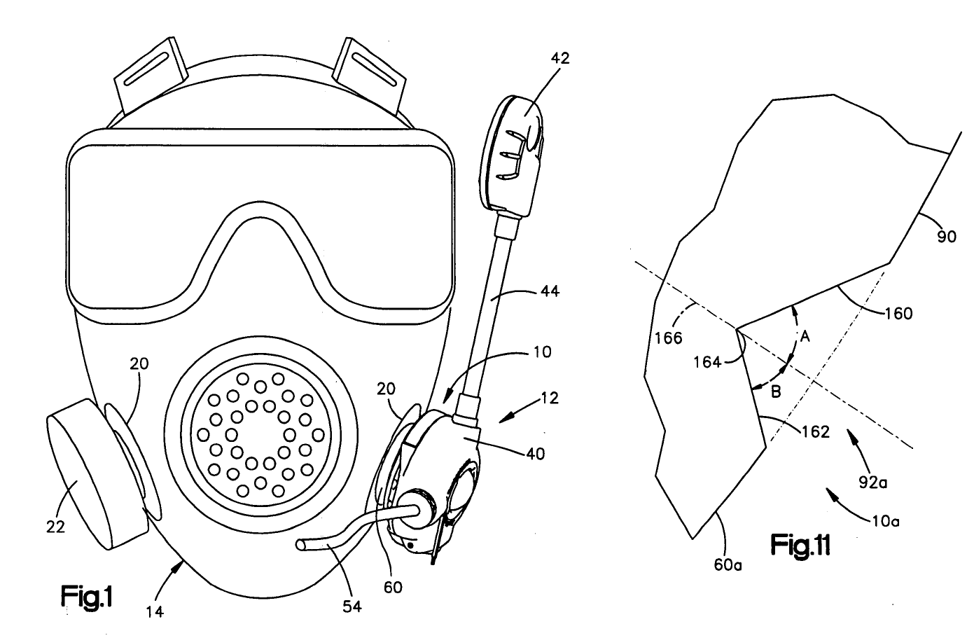

The present invention relates to a mask and to a way of supporting a device on a mask. In particular, the present invention relates to an adapter assembly for mounting a device, such as a communication device, on a portion of a mask, such as a filter port of a mask. The invention is applicable to masks and devices and adapter assemblies of varying types and constructions. As representative of the invention, FIG. 1 illustrates an adapter assembly 10 that is a first embodiment of the invention.

The adapter assembly 10 is shown supporting a communication device 12 on a mask 14. The mask 14 is made from rubber or another material suitable to prevent the person wearing it from inhaling air that is not filtered.

The mask 14 has two filter ports 20, each of which can support a filter that filters air for a person to breathe. Only one filter, supported on one filter port, is required to allow the person wearing the mask to breathe filtered air. The other filter port can be used for other functions or can be sealed. As shown in FIG. 1, the mask 14 supports a filter 22 on one of the filter ports 20.

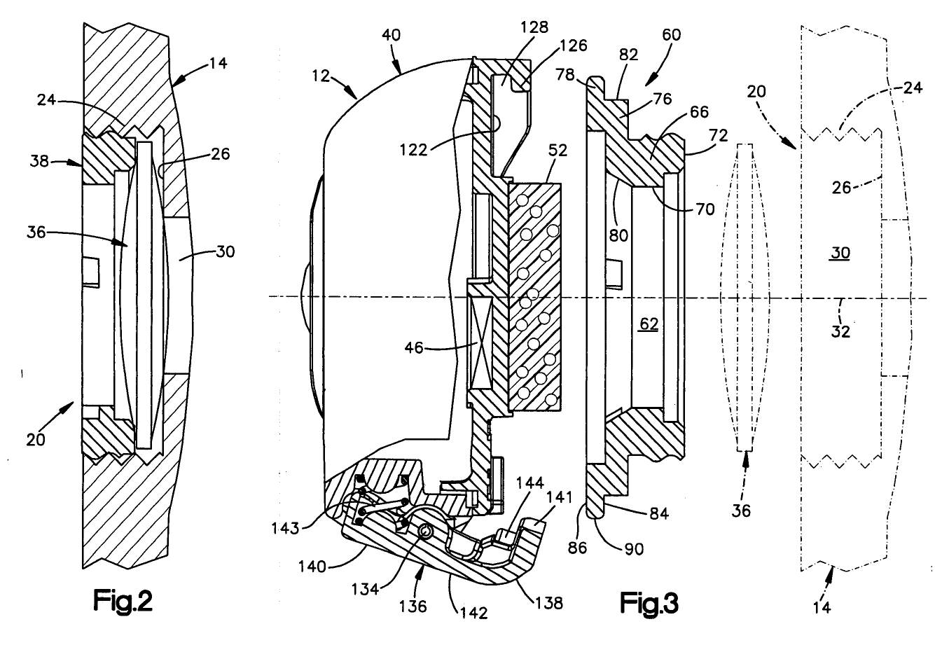

Each filter port 20 (FIGS. 2 and 3) has a sidewall 24 and an annular bottom surface 26 that define a circular opening 30 in the mask 14 centered on an axis 32. The sidewall 24 of the filter port is threaded.

One of the common uses for the second filter port 20 (i.e., the one not being used for a filter 22) is communication. When the second filter port 20 is used for communication, a voice emitter 36 is located in the filter port, as shown in FIG. 2. The voice emitter 36 is a thin, circular, metal diaphragm of a known construction. The voice emitter 36 is located on the bottom surface 26 of the filter port 20 and closes the opening 30. The voice emitter 36 is held in place in the filter port 20 by a seal ring 38 that is screwed into the sidewall 24. The engagement of the seal ring 38 in the filter port 20 seals the voice emitter against the mask 14.

In accordance with the invention, a device other than a filter or a voice emitter can be releasably supported on the mask 14. In the illustrated embodiment, the device 12 is a communication device that is supported on a filter port 20 of the mask 14. The communication device 12 allows the person wearing the mask 14 to transmit sound electronically away from the mask, and to hear other people who are transmitting sounds to the user. Other types of devices, to be supported on a mask, are suitable for use with the invention.

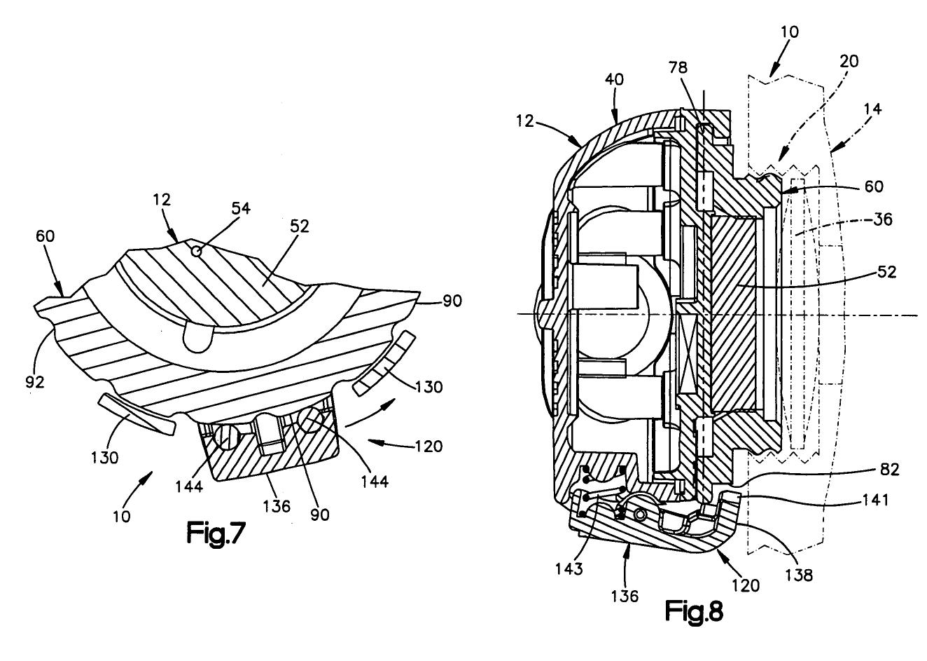

The communication device 12 shown in FIGS. 1-10 is a microphone and speaker combination. The device 12 includes a main body 40, and an ear speaker 42 (FIG. 1) on a boom 44. The main body 40 is generally circular in configuration and contains a microphone shown schematically at 46 (FIGS. 3-6). The main body 40 has a circular end surface 50. A foam pad 52 is attached to the end surface. The foam pad 52 is cylindrical with a diameter smaller than that of the threaded sidewall 24 of the filter port 20. A hole 54 extends through the foam pad 52 from the outer end of the foam pad to the main body 40. The hole 54 allows sound to travel through the foam pad 52 to the microphone 46 in the main body 40.

The boom 44 (FIG. 1) is a long, thin, member one end of which is attached to the main body 40 and the other end of which supports the speaker 42. A wire 54 connects the device 12 to an external amplifier and transceiver. Alternatively, an amplifier and transceiver may be located in the main body 40.

The adapter assembly 10 includes two pieces that are releasably connectable, to each other, to releasably support a device, such as the communication device 12, on the filter port 20 of the mask 14. The first piece of the adapter assembly 10 is an adapter ring 60. The adapter ring 60 is designed to be secured to the mask 14, replacing the seal ring 38, as described below. The second piece of the adapter assembly is a mounting assembly 120. The mounting assembly 120 is designed to be secured to or formed as part of the device 12 so that the device can be releasably connected with the adapter ring 60, as described below.

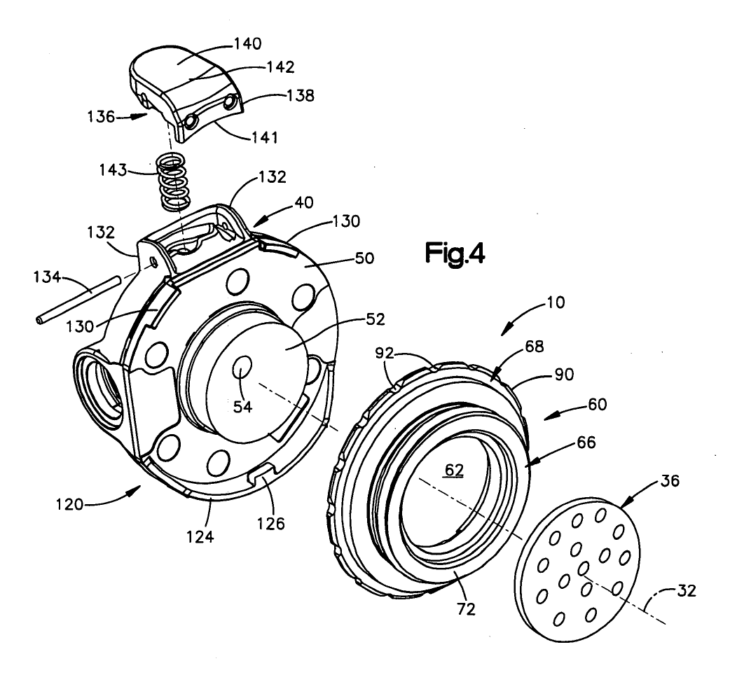

The adapter ring 60 (FIGS. 3 and 4) is preferably made as one piece, for example by molding, from a plastic material. The adapter ring 60 has a generally ring-shaped or annular configuration defining a central opening 62 that is centered on the axis 32. The adapter ring 60 includes a main body portion 66 and a flange portion 68.

The main body portion 66 of the adapter ring 60 is designed to replicate the seal ring 38. The main body portion 60 has a cylindrical inner surface 70 centered on the axis. The diameter of the inner surface 70 is slightly larger than the diameter of the foam piece 52 on the device 12. The main body portion 66 has external threads for attaching the adapter ring 60 to the filter port 20. The main body portion has an annular first end surface 72 for engagement with the voice emitter 36.

The flange portion 74 of the adapter ring 60 has an annular configuration including an inner section 76 and an outer section 78. The flange portion 74 of the adapter ring 60 has a larger outer diameter than the main body portion. The inner section 76 has an annular configuration and adjoins the main body portion 66 of the adapter ring 60. The inner surface 80 of the inner section 76 is angled and has a smaller diameter where it adjoins the main body portion 66 of the adapter ring 60 and a larger diameter at the other end. This angled surface 80 forms an inner guide surface of the adapter ring 60. A cylindrical outer surface 82 of the inner section 76 has a constant radius and forms an outer guide surface of the adapter ring 60.

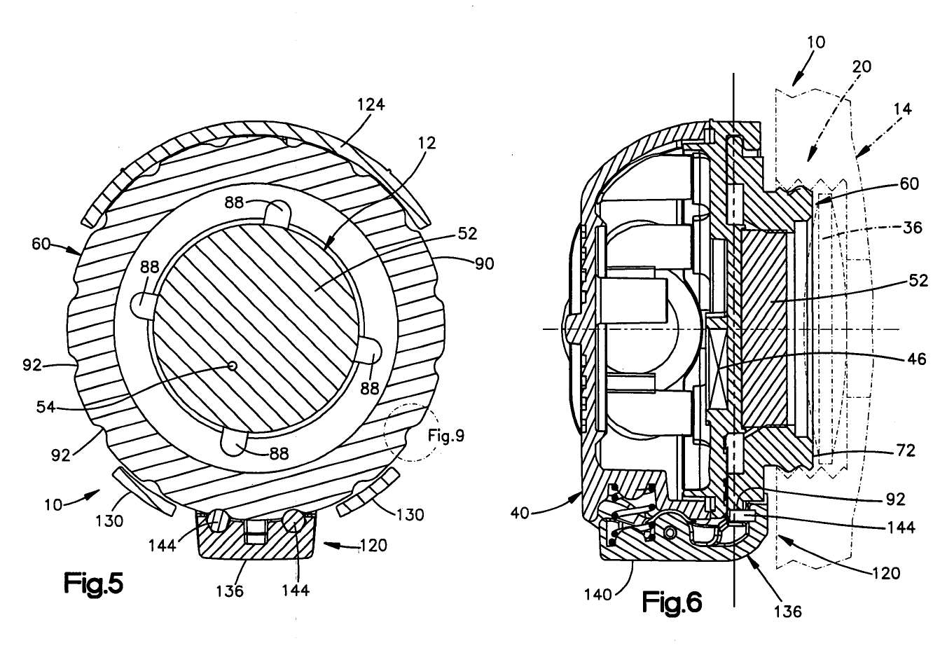

The outer section 78 of the flange portion 74 of the adapter ring 60 has parallel, radially extending end surfaces 84 and 86. The end surface 86 has four notches 88 (FIG. 5). These notches 88 are adapted to receive a spanner wrench for use in attaching the adapter ring 60 to the filter port.

The outer peripheral edge 90 of the outer section 78 of the flange portion 74 of the adapter ring 60 has a plurality of notches 92 that form a ratchet. The notches 92 are evenly spaced around the edge 90 and are all identical. Each notch 92 (FIG. 9) is defined by a notch surface 94 that is centered on an imaginary radially extending centerline 96. The centerline 96 defines a right side of the notch 92 (as shown in FIG. 9) and a left side of the notch that are different from each other.

The notch surface 94 includes a bottom surface portion 98 that has an arcuate configuration. A bottom point 100 is located on the bottom surface portion 98. The centerline 96 extends through the bottom point 100. The circumferential distance from the bottom point 100 of one notch 92 to the bottom point 100 of the next notch 92 is the same for each pair of adjacent notches on the adapter ring 60.

The notch surface 94 on the right side of the centerline 96 includes a right inner surface portion 104 that may be part of the bottom surface portion 98 and that extends from the bottom point to a right transition point 106. The notch surface 94 on the right side of the centerline 96 also includes a right radius surface 108 that extends from the right transition point 106 to the outer peripheral edge 90 of the adapter ring 60. The right radius surface 108 has a radius designated “A” in FIG. 9.

The notch surface 94 on the left side of the centerline 96 includes a left inner surface portion 110 that may be part of the bottom surface portion 98 and that extends from the bottom point 100 to a left transition point 112. The left transition point 112 is further from the bottom point 110 than is the right transition point 106. The notch surface 94 on the left side of the centerline 96 also includes a left radius surface 114 that extends from the left transition point 112 to the outer peripheral edge 90 of the adapter ring 60. The left radius surface 114 has a radius designated “B” in FIG. 9 that is less than the radius “A” is greater than the radius “B”.

The mounting assembly 120 may, as illustrated, be formed as one piece with (or be formed at least partially with) the device 12 that is to be supported on the adapter ring 60 and thereby on the mask 14. Alternatively, some or all of the mounting assembly 120 may be a separate device or structure that is connected to the device 12.

In the illustrated embodiment, the mounting assembly 120 is located on the circular end surface 50 of the main body 40 of the device 12. The mounting assembly 120 includes a mounting surface 122. In the present embodiment, the mounting surface 122 is formed as part or all of the circular end surface 50 of the main body 40. The mounting surface 122 may alternatively be formed into other shapes to accommodate mounting on devices having other configurations. The mounting assembly may if desired include a plate or other support piece or assembly that supports the various portions of the mounting assembly in position relative to each other and that can be secured to the device 12 to locate the mounting assembly on the device.

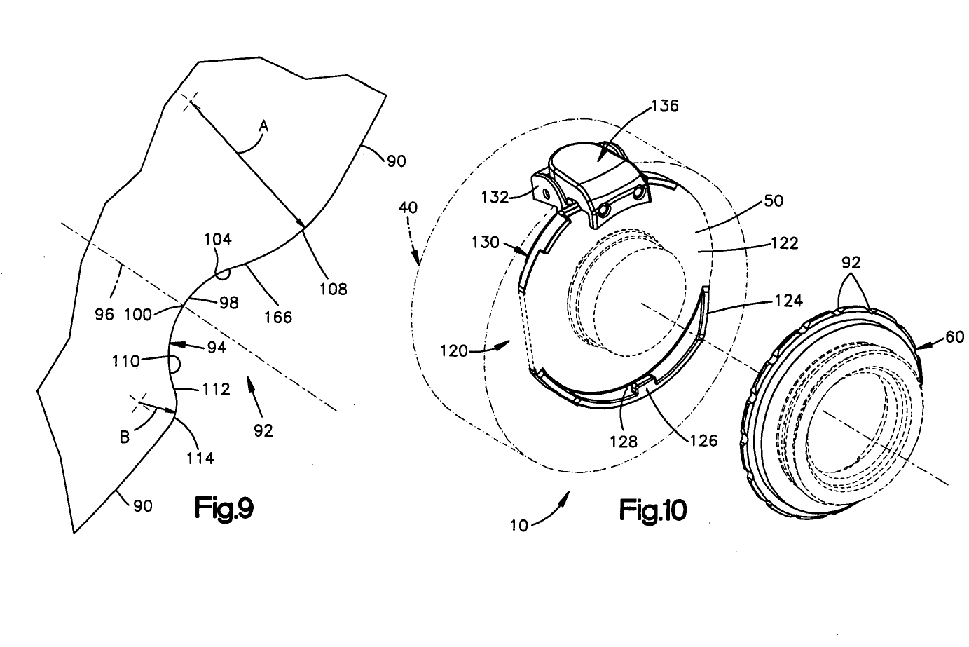

The mounting assembly 120 includes a plurality of walls that project axially from the mounting surface 122. The plurality of walls includes a first wall 124 that projects outward from the outer peripheral edge of the mounting surface 122. At the circumferential midpoint of the first wall 124, a tab 126 extends radially inward from the top edge of the first wall, in a direction parallel to but spaced apart from the mounting surface 122. As a result, a gap or space 128 (FIG. 10) is defined between the tab 126 and the surface 122.

The plurality of walls includes a second wall 130 that is located circumferentially opposite the first wall 124. The diametric distance between the first wall 124 and the second wall 130 is substantially the same as the outer diameter of the flange portion 74 of the adapter ring 60.

The mounting assembly 120 includes two flanges 132 that project axially outward from the side surface of the main body. The flanges 132 are located adjacent the second wall 130. Each flange 132 has a circular pivot pin opening that receives an end of a pivot pin 134.

The pivot pin 134 supports a pawl body 136. The pawl body 136 has three portions, an upper portion 138, a lower portion 140, and a middle portion 142. The pivot pin 134 extends through the middle portion 142 of the pawl body 136. As a result, the pawl body 136 is supported on the flanges 132, and thereby on the main body 40 of the communication device 12, for pivotal movement about the pivot pin 134 relative to the main body of the device.

The lower portion 140 of the pawl body 136 includes or is formed as a manually engageable finger plate. A compression spring 143 acts between the main body 40 and the lower portion 140 of the pawl body 138 to bias the pawl body into a first position as shown in FIG. 6. When the finger plate 140 is pressed, the spring 143 is compressed and the pawl body moves through an intermediate position as shown in FIG. 8 and into a second position as shown in FIG. 3.

The upper portion 138 of the pawl body 136 includes or is formed as a lip that extends over the mounting surface 122 when the pawl body is in the first position and in the intermediate position. The lip 138 has a front surface 141 that is curved to engage the outer guide surface 82 of the adapter ring 60.

The lip 138 supports two latch pins 144. The latch pins 144 are spaced apart by a circumferential distance that is equal to the distance between any two adjacent notches 92 on the adapter ring 60. The diameter of each latch pin 144 is preferably the same as the diameter of the bottom surface portion 98 of each notch 92 on the adapter ring 60.

To mount the adapter assembly 10 to the mask 14, the seal ring 38 is first removed from the filter port 20. In the illustrated embodiment, the seal ring 38 is unscrewed. This action removes the force on the voice emitter 36 and thereby breaks the seal between the voice emitter 36 and the mask 14. The voice emitter 36 remains in the filter port 20.

The main body portion 66 of the adapter ring 60 is then screwed in a “tightening” direction into the filter port 20. Torque is applied until the annular first end surface 72 of the main body portion 66 engages the voice emitter 33 with enough force to create a seal between the voice emitter and the mask 14. The adapter ring 60 of the adapter assembly 10 thus creates a new seal between the mask 14 and the voice emitter 36.

The device 12 is then connected with the mask 14 by connecting the mounting assembly 120 of the adapter assembly 10 with the adapter ring 60. Specifically, the user presses the finger plate 140 on the pawl body 34 with enough pressure to move the pawl body to the second position shown in FIG. 3. In this position, the pins 144 on the lip 138 of the pawl body 136 are moved away from the mounting surface 122. The flange portion 78 of the adapter ring 60 is then slid into the space 128 under the tab 126 that extends from the first wall 124 of the mounting assembly 120. Once the adapter ring 60 is under the tab 126, the adapter ring is moved toward and into engagement with the mounting surface 122.

The inner guide surface 80 of the adapter ring 60 guides the foam pad 52 into the central opening of the adapter ring 62. The adapter ring 60 is moved toward the mounting surface 122 until the second end surface 86 of the outer section 78 of the adapter ring 60 is flush against the mounting surface 122. When this occurs, the end of the foam pad 54 rests on the voice emitter 36. Pressure is then removed from the finger plate 140, allowing the spring 143 to move the pawl body 136 from the second position to the first position or to an intermediate position, in which the latch pins 144 are in contact with the adapter ring 60.

Once the main body 40 of the device 12 is thus placed on the adapter ring 60, the main body and the device as a whole can rotate about the axis 32 relative to the mask 14 and to the adapter ring.

Whenever the pawl body 136 is not pivoted out, the latch pins 144 of the mounting assembly 120 are in engagement with the flange portion 78 of the adapter ring 60. Depending on the position of rotation of the main body 40 relative to the adapter ring 60, the pins 144 are either in a first position resting in two adjacent notches 92 of the adapter ring, or in an intermediate position out of the notches and resting on the outer peripheral edge 90 of the adapter ring (between notches). When the pins 144 are in the notches 92, the engagement of the pins in the notches resists rotation of the main body 40 relative to the mask 14, thereby releasably holding the device 12 in the selected rotational position on the mask. When the pins 144 are not in the notches 92, the device 12 is more freely rotatable on the mask 14.

If the user desires to adjust the rotational position of the device 12 on the mask 14, the user applies force or torque to the device in either the “tightening” direction or an opposite “loosening” direction of rotation about the axis 32. This force is transmitted from the main body 40 to the mounting assembly 120. If sufficient force is applied, it overcomes the resistance of the latch pins 144 and the spring 143, and the pawl 134 is cammed outward against the bias of the spring. The mounting assembly 120 rotates on the adapter ring 60 about the axis 32. As this rotation occurs, the latch pins 144 move between the first and second positions.

If the main body 40 is in the first position and is rotated in the counter-clockwise or “loosening” direction (as viewed in FIG. 5) about the axis, each latch pin 144 moves from its resting position on the bottom surface 98 of a notch 92 and slides along the right inner surface portion 104. When the pin 144 passes the transition point 106, it moves along the right radius edge 108, which has a radius of “A”, up to the outer peripheral edge 90 of the adapter ring 60. The pin 144 is then in the intermediate position.

As the main body 40 and the mounting assembly 120 are thereafter rotated farther, the pins 144 slide along the outer peripheral surface 90 of the adapter ring 60 and into the location of the next pair of notches 92. The force of the spring 143 then moves the pawl 134 so that the pins 144 move into the notches 92. One pin 144 moves into a notch 92 that the other pin has just left; the other pin 144 moves to a new notch 92. The pins 144 when they enter the notches 92 move down the left side surface portions 114 and 110 until they rest on the bottom surfaces 98 of their respective notches. The engagement of the pins 144 in the notches 92, together with the force of the spring 143, again resists rotation of the mounting assembly 120 relative to the adapter ring 60, which resists rotation of the main body 40 relative to the mask 14, thereby releasably holding the device 12 in position on the mask.

When the main body 40 is rotated on the adapter ring in the counter-clockwise (loosening) direction (as viewed in FIGS. 1, 4, 5, 7, 9 and 10), torque is transferred from the main body to the adapter ring 60 and thereby from the adapter ring to the mask 14. Because the connection between the adapter ring 60 and the filter port 20 is a right hand screw threaded connection, if sufficient force were transferred from the main body 40 to the adapter ring 60 in this direction of rotation, the adapter ring might be loosened in the filter port 20, unscrewing a little and undesirably breaking the seal that is effected with the voice emitter 36. In accordance with the invention, however, and because of the presence of the ratchet mechanism that is formed by the pawl 134 and the adapter ring 60, the amount of torque required to move the main body 40 in the loosening direction is low enough so that when the main body is thus rotated on the adapter ring, the adapter ring is not rotated on the mask 14; while at the same time, that amount of required force is typically sufficient to hold the device 12, including the boom 44 and ear speaker 42, in the selected position during normal movements of the user's head. This minimizes the possibility that intentionally or accidentally moving the device 12 in this loosening direction of rotation will cause the adapter ring 60 to loosen and break the seal.

Specifically, the amount of torque needed to rotate the mounting assembly 120 in one direction or the other on the adapter ring 60 is determined by, among other factors, the spring force of the spring 143, the depth of the notches 92, the angle of the notch side surfaces relative to the notch centerline 96, etc. Because the radius “A” is greater than the radius “B”, more torque is required to move a latch pin 144 from the bottom 100 of a notch 92 along the complete left side of the notch 92, as compared to moving the pin up the opposite, right side of the notch. Therefore, more torque is needed to cause a clockwise (or tightening) rotation of the main body 40 on the mask 14 than is required to cause a counter-clockwise (or loosening) rotation of the main body. Thus, the device 12 rotates more easily in the “loosening” direction, to prevent enough torque from being transmitted to the adaptor ring 60 to loosen it in the filter port 20. The additional torque required to move the main body 40 in the clockwise or “tightening” direction, makes it more difficult to accidentally move the device 12 in that direction.

Removal of the attached device 12 from the mask 14 is accomplished by applying force to the pawl 136 to pivot the pawl about the pivot pin. When this is done, the latch pins 144 move away from the mounting surface 122 far enough so that the mounting assembly 120 can be removed from the adapter ring 60. Thus, the mounting assembly 120 is releasably attachable to and detachable from the adapter ring 60 and, as a result, the device 12 is releasably attachable to and detachable from the mask 14.

FIG. 11 illustrates a portion of an adapter assembly 10a that is a second embodiment of the invention. The illustrated portion is a notch 92a of an adapter ring 60a. In this alternative embodiment, the notch 92a has linear sides rather than curved or arcuate sides. A linear left side surface 160 and a linear right side surface 162 meet at a bottom point 164. The surfaces 160 and 162 extend at different angles A and B to the imaginary centerline 166 of the notch 92a. The angle A is greater than the angle B. Therefore, it requires more force to move a pin out the right side (as viewed in FIG. 11) of the notch 92a than out the left side of the notch, and so it requires more torque to cause a clockwise rotation of the pin (as viewed in FIG. 11) relative to the adapter ring 90a than to cause a counter clockwise rotation.

From the above description of the invention, those skilled in the art will perceive improvements, changes, and modifications in the invention. Such improvements, changes, and modifications within the skill of the art are intended to be included within the scope of the appended claims.

Having described the invention, we claim:

1. An adapter assembly for attaching a device to a filter port of a mask, comprising:
an adapter ring that attaches to the mask to effect a seal of the filter port; and
a mounting assembly that attaches to the device and that is releasably engageable with the adapter ring to support the device on the mask for rotation relative to the mask without breaking the seal of the filter port.

2. An adapter assembly as set forth in claim 1 wherein at least a portion of the mounting assembly is formed with the device.

3. An adapter assembly as set forth in claim 1 wherein the mounting assembly is formed separately from the device.

4. An adapter assembly as set forth in claim 1 wherein the adapter ring attaches to the mask with a threaded connection, and wherein the mounting assembly is rotatable on the adapter ring in response to a first amount of force applied to the device in a loosening direction of the threaded connection and in response to a second amount of force applied to the device, greater than the first amount, in a tightening direction of the threaded connection.

5. An adapter assembly as set forth in claim 4 wherein the adapter ring has notches receiving pins on the mounting assembly and defining rotational positions of the device relative to the mask, the notches being asymmetrical so that the pins are movable out of the notches in the loosening direction of rotation with less force than in the tightening direction of rotation.

6. An adapter assembly as set forth in claim 1 wherein the adapter ring forms a ratchet and the mounting assembly forms a pawl engageable with the ratchet to control rotation of the device on the mask.

7. An adapter assembly as set forth in claim 6 wherein the pawl is rotatable relative to the ratchet in first and second opposite directions in response to first and second different amounts of force.

8. An adapter assembly as set forth in claim 6 wherein the pawl is pivotable relative to the device to enable attachment and detachment of the device from the adapter ring.

9. An adapter assembly as set forth in claim 1 wherein the mounting assembly includes a portion that is pivotable relative to the device to enable attachment and detachment of the device from the adapter ring.

10. An apparatus comprising:
a mask;
a communication device; and
a ratchet mechanism supporting the communication device on the mask for rotation relative to the mask.

11. An apparatus as set forth in claim 10 wherein the mask has a filter port and the ratchet mechanism supports the communication device on the filter port of the mask.

12. An apparatus as set forth in claim 11 wherein the ratchet mechanism includes an adapter ring mounted on the filter port and forming a ratchet, the ratchet mechanism also including a mounting assembly mounted on the communication device and forming a pawl engageable with the ratchet.

13. An apparatus as set forth in claim 12 wherein the ratchet comprises a plurality of notches on the adapter ring.

14. An apparatus as set forth in claim 13 wherein the notches receive pins on the mounting assembly and define rotational positions of the device relative to the mask, the notches being asymmetrical so that the pins are movable out of the notches in the second direction of rotation with less force than in the first direction of rotation.

15. An adapter assembly for attaching a device to a filter port of a mask, comprising:
an adapter ring that when mounted tightly to the mask effects a seal of the filter port; and
a mounting assembly that supports the device on the adapter ring for rotation in first and second opposite directions of rotation relative to the adapter ring;
a greater torque being required to rotate the device relative to the adapter ring in the first direction of rotation than in the second direction of rotation.

16. An adapter assembly as set forth in claim 15 wherein the adapter ring has notches receiving pins on the mounting assembly and defining rotational positions of the device relative to the mask, the notches being asymmetrical so that the pins are movable out of the notches in the second direction of rotation with less force than in the first direction of rotation.

17. An adapter assembly as set forth in claim 16 wherein the notches have curved sides with different radii of curvature.

18. An adapter assembly as set forth in claim 16 wherein the notches have linear sides extending at different angles relative to the centerlines of the notches

19. An adapter assembly as set forth in claim 15 wherein the adapter ring is mounted to the mask with a threaded connection and wherein the first direction of rotation is a tightening direction of the threaded connection and the second direction of rotation is a loosening direction of the threaded connection.

20. An apparatus comprising:
a mask having a filter port to be sealed;
a communication device; and
means for supporting the communication device on the mask for rotation relative to the mask without breaking the seal of the filter port.

21. An apparatus as set forth in claim 20 wherein the means for supporting comprises a ratchet mechanism.

22. An apparatus as set forth in claim 21 wherein the ratchet mechanism supports the device on the mask in discrete rotational positions, the device being movable from one position to the next in a first direction of rotation in response to the application of a first amount of force and in a second direction of rotation in response to the application of a second amount of force that is greater than the first amount of force.

23. An apparatus as set forth in claim 22 wherein the ratchet mechanism is connected with the mask by a threaded connection, and wherein the first direction of rotation is a loosening direction of the threaded connection and the second direction of rotation is a tightening direction of the threaded connection.

24. An apparatus as set forth in claim 20 wherein the ratchet mechanism comprises means for setting rotational positions of the device on the mask out of which the device is movable with differing amounts of force in different direction of rotation.
